(19) United States
(12) Patent Application Publication
(10) Pub. No.: US 2007/0108883 A1
(43) Pub. Date: May 17, 2007

(54) Unified magnetic shielding of tensioned mask/frame assembly and internal magnetic shield

(76) Inventors: Peter Finkel, Downingtown, PA (US); Rein Roman Mutso, Lancaster, PA (US)

Correspondence Address: Joseph S Tripoli;Thomson Licensing Inc, PO Box 5312, Princeton, NJ, 08543-5312, US

(21) Appl. No.: 11/597,094

(22) PCT Filed: Aug. 12, 2004
(86) PCT No.: PCT/US04/26160

§ 371 Date: Nov. 21, 2006

(51) Int. Cl. H01J 29/02

(52) U.S. Cl. 313/479

(57) ABSTRACT

The present invention provides a cathode ray tube, comprising: a tensioned mask frame for supporting a tension mask inside the CRT at a cantilevered edge thereof, a tension mask mounted on the tension mask frame at the cantilevered edge; and an internal magnetic shield mounted on the tension mask frame. At least one of the tension mask and the internal magnetic shield have an extension extending along the tensioned mask frame to a point proximate or contacting the other of the tension mask and the internal magnetic shield to provide magnetic coupling between the tension mask and the internal magnetic shield independent of the tensioned mask frame.

### CROSS-REFERENCE TO RELATED APPLICATIONS

This application claims the benefit of U.S. Provisional Patent Application Ser. No. 60/574,887, entitled “CRT Having a Unified Magnetic Shielding of Tensioned Mask/Frame Assembly and Internal Magnetic Shield” and filed May 27, 2004, which is incorporated by reference herein in its entirety.

### FIELD OF THE INVENTION

This invention generally relates to cathode ray tubes (CRTs) and, more particularly, to a shielding arrangement for a tensioned mask/frame assembly and an internal magnetic shield (IMS).

### BACKGROUND OF THE INVENTION

A color cathode ray tube, or CRT, includes an electron gun for forming and directing three electron beams to a screen of the tube. The screen is located on the inner surface of the faceplate panel of the tube and is made up of an array of elements of three different color-emitting phosphors. A shadow mask, which may be either a formed mask or a tension mask having strands or a membrane with slitted apertures with or without tie bars, is located between the electron gun and the screen. The electron beams emitted from the electron gun pass through apertures in the shadow mask and strike the screen causing the phosphors to emit light so that an image is displayed on the viewing surface of the faceplate panel.

A tension mask comprises a set of strands that are tensioned onto a mask frame to reduce their propensity to vibrate at large amplitudes under external excitation. Such vibrations would cause gross electron beam misregister on the screen and would result in objectionable image anomalies to the viewer of the CRT.

Another source of electron beam misregister and beam motion is residual magnetism within the CRT. To remove this residual magnetism, a degaussing process is performed. One of the controlling parameters for optimizing magnetic performance of a tube is degauss recovery. Good degauss recovery manifests itself in low beam motion with the tube located in the external earth magnetic field and in good register of the electron beam with the phosphor element on the screen, after the tube has undergone a degaussing process to set up balancing fields in the IMS, mask, and frame components inside the CRT. With the introduction of true flat CRT's that use tension masks, including focus tension masks, optimization of magnetic shielding by degaussing has become more difficult.

During tube degaussing, existing IMS's must achieve effective magnetic field coupling with the mask through an intervening frame. In tension mask CRT designs, the mask is attached to a rigid frame. In order to maintain tension in the tension mask, the frame has to have high yield stress, which is usually accompanied by poor magnetic properties, i.e., high coercive force and low permeability. This makes degaussing the frame difficult, provides poor flux coupling during the degaussing process, and leaves very high residual magnetic fields inside the CRT. These residual magnetic fields cause the CRT to have very high electron beam misregister, poor purity and poor picture quality.

It is desirable to develop an improved mask frame assembly that allows tension masks to be uniformly degaussed.

### SUMMARY OF THE INVENTION

The present invention therefore provides a cathode ray tube (CRT), comprising: a tensioned mask frame for supporting a tension mask inside the CRT at a cantilevered edge thereof, a tension mask mounted on the tension mask frame at the cantilevered edge; and an internal magnetic shield mounted on the tension mask frame. At least one of the tension mask and the internal magnetic shield have an extension extending along the tensioned mask frame to a point proximate or contacting the other of the tension mask and the internal magnetic shield to provide magnetic coupling between the tension mask and the internal magnetic shield independent of the tensioned mask frame.

### BRIEF DESCRIPTION OF THE DRAWINGS

The invention will now be described by way of example with reference to the accompanying figures of which:

FIG. 1 is a sectional plan view of a typical cathode ray tube;

FIG. 2 is a front view of a tension mask/frame assembly from the cathode ray tube of FIG. 1, showing a partial cut-away of the tension mask;

FIG. 3 is a perspective sectional view of an existing tension mask/frame assembly and internal magnetic shield arrangement;

FIG. 4 is a sectional side view of a tension mask/frame assembly and internal magnetic shield arrangement according to an exemplary embodiment of the present invention;

FIG. 5 is a sectional side view of a tension mask/frame assembly and internal magnetic shield arrangement according to another exemplary embodiment of the present invention;

FIG. 6 is a sectional perspective side view of a tension mask/frame assembly and internal magnetic shield arrangement according to yet another exemplary embodiment of the present invention;

FIG. 7 is a sectional perspective side view of a tension mask/frame assembly and internal magnetic shield arrangement according to yet another exemplary embodiment of the present invention;

FIG. 8 is a sectional side view of a tension mask/frame assembly and internal magnetic shield arrangement according to yet another exemplary embodiment of the present invention;

FIG. 9 is a sectional side view of a tension mask/frame assembly and internal magnetic shield arrangement according to yet another exemplary embodiment of the present invention; and

FIG. 10 is a sectional side view of a tension mask/frame assembly and internal magnetic shield arrangement according to yet another exemplary embodiment of the present invention.

### DETAILED DESCRIPTION OF THE INVENTION

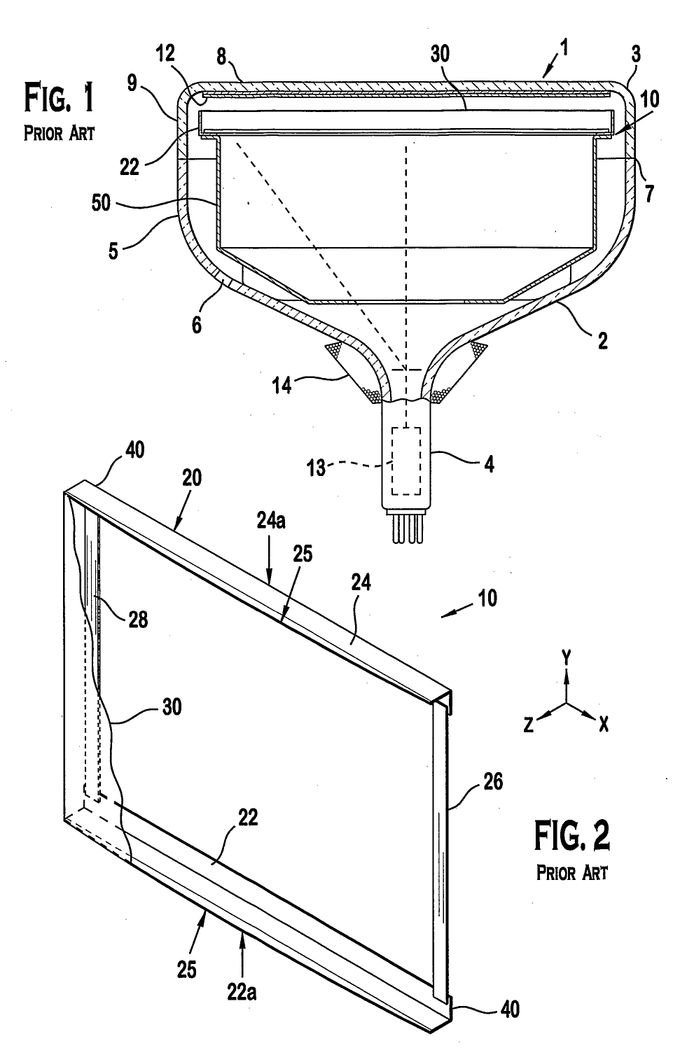

FIG. 1 shows a cathode ray tube (CRT) 1 having a glass envelope 2 comprising a rectangular faceplate panel 3 and a tubular neck 4 connected by a funnel 5. The funnel 5 has an internal conductive coating (not shown) that extends from an anode button 6 toward the panel 3 and to the neck 4. The panel 3 comprises a substantially cylindrical or a rectangular viewing faceplate 8 and a peripheral flange or sidewall 9, which is sealed to the funnel 5 by a glass frit 7. A three-color phosphor screen 12 is carried by the inner surface of the faceplate 3. The screen 12 is a line screen with the phosphor lines arranged in triads, each of the triads including a phosphor line of each of the three colors. A color selection tension mask assembly 10 is removably mounted in predetermined spaced relation to the screen 12. An electron gun 13, shown schematically by dashed lines in FIG. 1, is centrally mounted within the neck 4 to generate and direct three inline electron beams, a center beam and two side or outer beams, along convergent paths through the tension mask assembly 10 to the screen 12.

The tube 1 is designed to be used with an external magnetic deflection yoke 14 shown in the neighborhood of the funnel-to-neck junction. When activated, the yoke 14 subjects the three beams to magnetic fields which cause the beams to scan horizontally and vertically in a rectangular raster over the screen 12.

The tension mask assembly 10, as shown in FIG. 2, has a metal frame 20 that includes two long sides 22 and 24, and two short sides 26 and 28. The two long sides 22, 24 of the frame are parallel to a central major axis, X, of the tube; and the two short sides 26, 28 parallel a central minor axis, Y, of the tube. Although the tension mask assembly 10 is shown here diagrammatically as a sheet for simplicity, it includes an apertured shadow mask 30 that contains a plurality of metal strips (not shown) having a multiplicity of elongated slits (not shown) therebetween that parallel the minor axis of the shadow mask 30. The long sides 22, 24 have a cantilever edge 25 extending toward the screen 12.

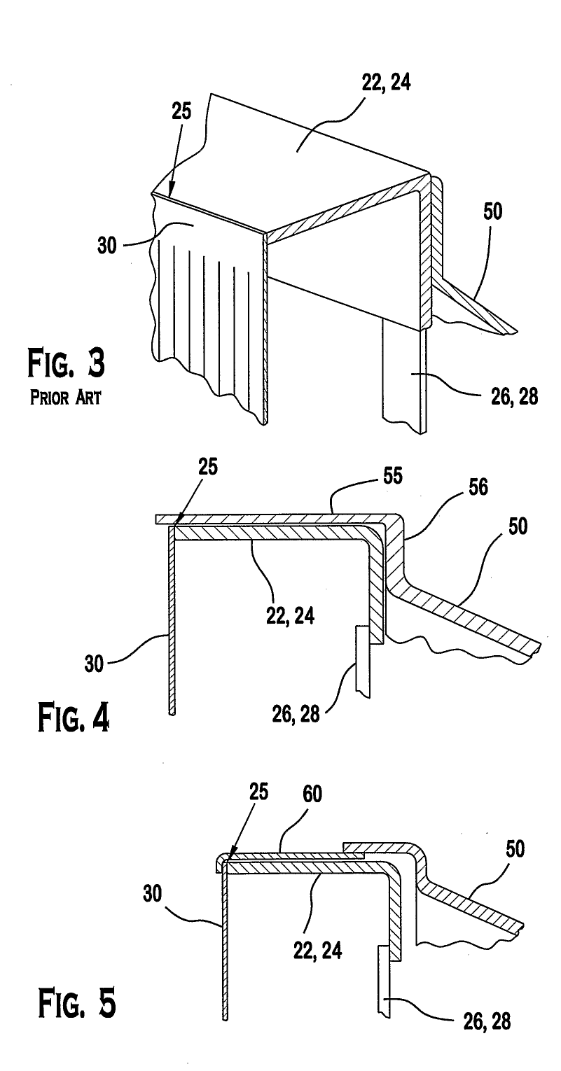

In an existing arrangement of a tension mask assembly 10 and an internal magnetic shield (IMS) 50, as shown in FIG. 3, the tension mask 30 is attached to the cantilever edge 25 of the long sides 22, 24 of the tensioned mask frame. The attachment may be performed, for example, by welding. The IMS 50 is attached to the long sides of the frame 20 at a location removed from the tension mask 30. In the embodiment illustrated in FIG. 3, the long sides 22, 24 of the frame 20 comprise L-shaped bars or angles formed by two legs at a right angle to each other with the cantilever edge 25 on the end of one leg and the IMS 50 attached to the other leg. Thus, the existing shielding arrangement provides magnetic flux coupling through the tensioned mask frame 20.

In this arrangement, the IMS 50, tension mask 30 and frame 20 are made from low carbon steel or iron-nickel alloys. Magnetic shielding and degaussing ability of the tension mask 30, tensioned mask frame 20, and IMS 50 system are improved if each of the components has high anhysteretic permeability and low coercivity. However, the tensioned mask frame 20 must have high yield stress to provide the rigidity necessary for proper function. This high yield stress is usually accompanied by poor magnetic properties, e.g., high coercivity and low permeability. Even if the coercivity of the tension mask 30 and the IMS 50 are low, indicating good magnetic properties, the overall performance of the tube is deteriorated if the coercivity of the tensioned mask frame 20 is high, indicating poor magnetic properties. Having high magnetic reluctance, the tensioned mask frame 20 increases the reluctance of the IMS/frame/mask assembly. Additionally, a residual magnetic field is retained after degaussing at the interface of the tension mask 30 and the tensioned mask frame 20 that is difficult to remove and leads to beam misregister. Conventional degaussing is performed using a special degaussing coil placed close to the IMS 50, and will degauss the IMS 50 adequately. Conventional degaussing, however, will do very little to remove residual magnetic fields from the high coercivity tensioned mask frame 20 and the tension mask 30 behind it. The tensioned mask frame 20 causes the earth magnetic field to be distorted and concentrated at particular points, which can magnetize the tension mask 30 and IMS 50 when the tube is degaussed. In addition, a residual magnetic field exists due to the high coercivity tensioned mask frame 20 that is difficult to remove and leads to beam misregister.

In an exemplary embodiment of the present invention, as shown in FIG. 4, the tension mask 30 is attached to the long sides 22, 24 of the frame 20 at the cantilever edges 25. The IMS 50 has extensions 55, 56 formed on the end of the IMS 50 at a right angle to one another corresponding to the surfaces of the long sides 22, 24 of the tensioned mask frame 20. When the IMS 50 is attached to the tensioned mask frame 20, the extension 55 extends along the tensioned mask frame 20 to a location proximate the cantilevered edge 25, where the tension mask 30 is attached to the tensioned mask frame 20. The extension 55 may, but does not have to contact the tension mask 30. Optionally, the IMS 50 of this embodiment may be attached to the tensioned mask frame, only at the extension 56 for ease of access during assembly. It should be noted that the extension 55 need not touch the IMS 50 to provide magnetic coupling. Thus, the tension mask 30 and the IMS 50 may be magnetically coupled through a small gap with minimal magnetic flux leakage. Optionally, the IMS 50 of this embodiment may be attached to the tensioned mask frame, only at the extension 56 for ease of access during assembly.

In an alternative exemplary embodiment of the present invention, as shown in FIG. 5, one or more joining members 60 are attached to the tension mask 30 at the cantilevered edge 25 of the tensioned mask frame 20 and are attached to the IMS 50 at a location removed from the cantilevered edge 25. The joining members 60 may be formed of a material having a high magnetic permeability, such as steel. The joining members 60 may be very thin to minimize the risk of contact with the walls of the tube or other structures within the tube. Also, the ends of the joining members 60 may be flat or bent on either or both sides to aid contact with the tension mask 30. The joining members 60 may be attached to the tensioned mask frame 20, but such attachment is not required.

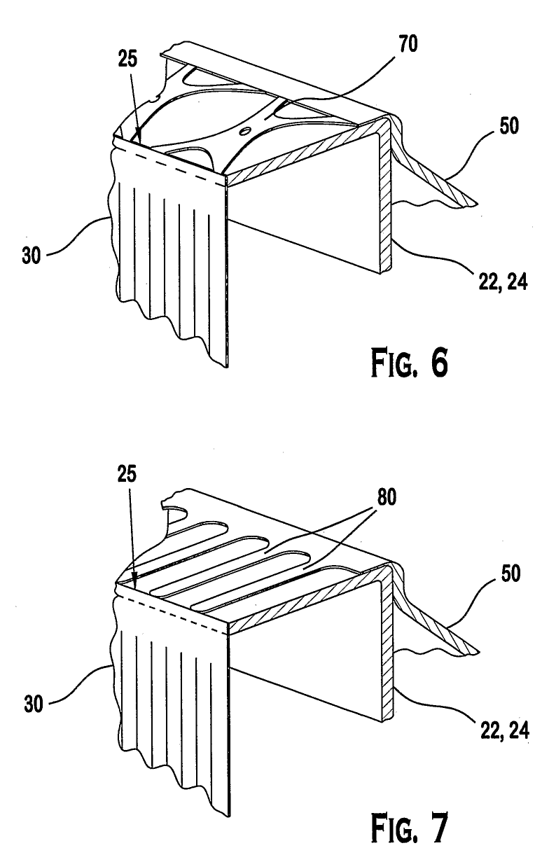

In another alternate embodiment of the present invention, as shown in FIG. 6, a flexible mesh 70 comprising a ferromagnetic material extends between the tension mask 30 and the IMS 50. The mesh 70 may extend under the tension mask 30 and the IMS 50 as shown in FIG. 6. The IMS 70 may extend around the corner of the angled long side 22, 24 of the tensioned mask frame, as shown in FIG. 6. Alternatively, the mesh 70 may extend around the corner of the angled long side 22, 24, allowing additional clearance. The mesh 70 may be attached to the tension mask 30 and IMS 50 using attachment means, such as welding, and may be welded to the tensioned mask frame 20 together with the tension mask 30 and IMS 50.

In another alternate embodiment of the present invention, as shown in FIG. 7, one or more tabs 80 are formed on the end of the IMS 50, such that they extend toward the tension mask 30 when the IMS 50 is mounted on the tensioned mask frame 20. The tabs 80 may vary in size and spacing to provide adequate magnetic coupling between the IMS 50 and the tension mask 30. The tabs 80 may extend under the tension mask 30 at cantilevered edge 25 or may be attached to the tensioned mask frame 20 proximate cantilevered edge 25. While tabs 80 are shown extending from the IMS 50, tabs may alternatively be formed that extend from the tension mask 30 and extend toward the IMS 50.

In another alternative embodiment of the present invention, as shown in FIG. 8, a coating 90 is applied to the tensioned mask frame 20 between the attachment locations for the tension mask 30 and the IMS 50. The coating comprises a material with a high magnetic permeability, providing magnetic coupling of the tension mask 30 to the IMS 50. The coating 90 may extend onto the cantilevered edge 25 of the tensioned mask frame 20 and to a location on the tensioned mask frame 20 removed from the cantilevered edge 25, such that it contacts the tension mask 30 and the IMS 50 when they are attached to the tensioned mask frame 20. Alternatively, the coating 90 may extend proximate the tension mask 30 and IMS 50 but not be in contact with either or both.

In yet another alternative exemplary embodiment of the present invention, as shown in FIG. 9, the tension mask has extensions 35 which extend beyond the cantilevered edges 25. These extensions 35, which are formed as part of the tension mask 30 are then positioned extending along the tensioned mask frame 20 to a position proximate or in contact with the IMS 50, removed from the cantilevered edges 25, where the extensions 35 are attached to the tensioned mask frame 20. The IMS 50 and extensions 35 may be attached to the tensioned mask frame 20 using common attachment means, which may be, for example, spot welds.

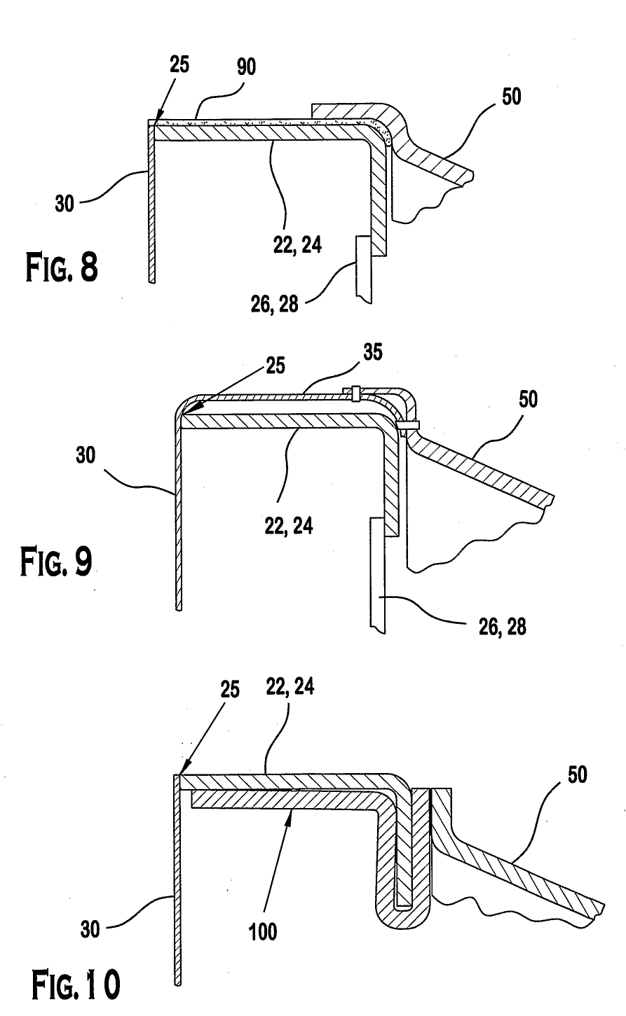

In yet another alternative embodiment, shown in FIG. 10 an extension 100 is attached to the long sides 22, 24 of the frame 20, extending from the IMS 50 along the inside surface of the frame toward the mask 30. The extension 100 comprises a material having high magnetic permeability, as compared to the frame 20. The extension 100 may be a separate part attached by press fitting, for example onto the edge opposite the cantilevered edge 25. The extension 100 can be inserted from the interior of the tension mask frame 20 providing enhanced shielding of the frame 20. It should be noted that the extension 100 may contact the mask 30, but physical contact is not required, as long as the extension 100 extends to a point proximate the mask 30.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A cathode ray tube comprising:
a tensioned mask frame for supporting a tension mask inside the CRT at a cantilevered edge thereof,
a tension mask mounted on the tension mask frame at the cantilevered edge; and
an internal magnetic shield mounted on the tension mask frame; wherein
at least one of said tension mask and said internal magnetic shield having an extension extending along said tensioned mask frame to a point proximate or contacting the other of said tension mask and said internal magnetic shield to provide magnetic coupling between said tension mask and said internal magnetic shield independent of said tensioned mask frame.

2. The cathode ray tube of claim 1 wherein said tension mask and said internal magnetic shield are not in physical contact with each other.

3. The cathode ray tube of claim 1 wherein the extension is an extension of the tension mask which overlaps the internal magnetic shield.

4. The cathode ray tube of claim 1 wherein the extension is a joining member attached to the tension mask proximate the cantilever edge and to the internal magnetic shield proximate a location on the tensioned mask frame removed from the cantilevered edge.

5. The cathode ray tube of claim 1 wherein the extension is a flexible mesh comprising a ferromagnetic material extending between the tension mask and the internal magnetic shield.

6. The cathode ray tube of claim 5 wherein the flexible mesh is attached to the tension mask proximate the cantilever edge and to the internal magnetic shield proximate a location on the tensioned mask frame removed from the cantilevered edge.

7. The cathode ray tube of claim 1 wherein said extension is at least one tab formed on an edge of the mask, extending along said tensioned mask frame to a location proximate or contacting the internal magnetic shield.

8. The cathode ray tube of claim 7 wherein the at least one tab is attached to the tensioned mask frame at the location proximate or contacting the internal magnetic shield.

9. The cathode ray tube of claim 8 wherein the tab and the internal magnetic shield are attached to the tensioned mask frame by a common attachment means.

10. The cathode ray tube of claim 1 wherein said extension is at least one tab formed on an edge of the internal magnetic shield, extending along said tensioned mask frame to a location proximate or contacting the tensioned mask.

11. The cathode ray tube of claim 10 wherein the tab is attached to the tensioned mask frame at the location proximate or contacting the tensioned mask.

12. The cathode ray tube of claim 1 wherein said extension is a coating of highly permeable magnetic material applied to said tensioned mask frame between said tension mask and said internal magnetic shield.
